(19) United States
(12) Patent Application Publication
(10) Pub. No.: US 2007/0101853 A1
(43) Pub. Date: May 10, 2007

(54) Method of applying a graphic design to a guitar

(75) Inventor: George Staleos, Pewaukee, WI (US)

Correspondence Address: RYAN KROMHOLZ & MANION, S.C., POST OFFICE BOX 26618, MILWAUKEE, WI, 53226, US

(73) Assignee: Consumer Electronics Corp.

(21) Appl. No.: 11/269,338

(22) Filed: Nov. 8, 2005

(51) Int. Cl. G10D 3/00

(52) U.S. Cl. 84/291

(57) ABSTRACT

A method for application of a custom image or graphic to a substrate or surface. The process is specifically designed for use on guitars. Once a graphic is applied to the surface, the process integrates the graphic with the surface, which results in the graphic being indistinguishable from the surface. The resultant surface includes an intricate design that is capable of being reproduced quickly and efficiently.

### BACKGROUND OF THE INVENTION

The present invention relates to processes and methods for applying a graphic or image to a substrate or surface and, more particularly, to processes and methods for applying a graphic or image to a guitar surface.

Several processes and methods are known and used for placing graphics on a substrate or surface, including heat transfer methods, adhesive-based processes, and engraving or etching methods, to name a few. For instance, Martino, U.S. Pat. No. 6,461,676, “Semi-finished Wood Simulating Product and Method”, describes a method for providing a simulated wood finish to a substrate and Ellison, U.S. Pat. No. 6,399,193, “Surface Laminate with Bonded with Pigmented Pressure Sensitive Adhesive,” describes a method for painting an automobile and the like.

While these methods have worked well for their intended purposes, they are directed towards simple designs and patterns, and generally to solid color layers. Each method may not necessarily work for specific applications, such as detailing and finishing the surface of a musical instrument with a custom design or image. For instance, when finishing high end products where the detail of the graphic placed upon the surface of the product is important, the above-mentioned prior art leave room for improvement. It is becoming more common to manufacture guitars with a picture or design on the guitar surface. Care must be taken not to damage the guitar surface, while sufficiently protecting the image that is placed on the surface.

Guitars have been manufactured with a picture or image on the face of the guitar, with the image usually consisting of a sticker. The stickers usually peel after time, which is not only aesthetically unappealing, but can also interfere with the actual playing of the guitar. The prior art is not capable of laminating and finishing the surface of the guitar with the precision and detail that is desired for an aesthetically pleasing guitar that can be played normally. Detailing and customizing processes take an extremely long amount of time, and mass-production methods, such as mentioned for a vehicle, are not capable of incorporating intricate graphics and images onto the finished surface.

It has been known for guitars, especially electric guitars, to be customized for an individual. These processes do not usually relate to supplying an actual image to the guitar, but airbrushing or painting a design onto the guitar. However, such processes cannot be done quickly and efficiently for a large number of guitars and, also, are generally more concerned with painting the guitar rather than applying a design to the guitar. Furthermore, such processes are generally limited in their use on electric guitars and have not been adapted for use on acoustical guitars.

An efficient process for finishing guitars in large, reproducible numbers that would also be capable of applying a high quality picture or image to the guitar without distorting or diminishing the quality of the picture or image is needed. Such a process should also be applicable to both electric guitars and acoustic guitars.

### SUMMARY OF THE INVENTION

The present method allows application of an image or graphic to a substrate or surface. The process is specifically designed for use on guitars. Once a graphic is applied to the surface, the process melds the graphic with the surface, which results in the graphic being indistinguishable from the surface. The resultant guitar can include an intricate design that is capable of being reproduced quickly and efficiently.

Initially the guitar body will be buffed with a buffing wheel prior to putting any coatings on the body the guitar. The method consists of hand applying an undercoating layer, such as polyethylene, to the guitar surface, then buffing again. A second layer of undercoating is applied to the surface and allowed to dry for approximately 48 hours. The surface is once again hand buffed. An image or graphic is laminated to the surface, with additional layers of protective and finishing paint applied to the surface.

### BRIEF DESCRIPTION OF THE DRAWINGS

FIG. 1 is a perspective view of a guitar having an image applied to the guitar in accordance with the present invention.

FIG. 2 is a partial side exploded view of a finished surface in accordance with the present invention.

FIG. 3 shows an image for use with the present invention.

FIG. 4 shows the image of FIG. 3 being treated for lamination purposes.

FIG. 5 shows a perspective exploded view of a guitar and the image of FIG. 4.

FIG. 6 shows a perspective view of the guitar and the image of FIG. 5.

FIG. 7 shows a perspective view of a further layer being applied to the guitar of FIG. 6.

FIG. 8 shows a perspective view of a further layer being applied to the guitar of FIG. 7.

FIG. 9 is a flow chart depicting a preferred embodiment of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

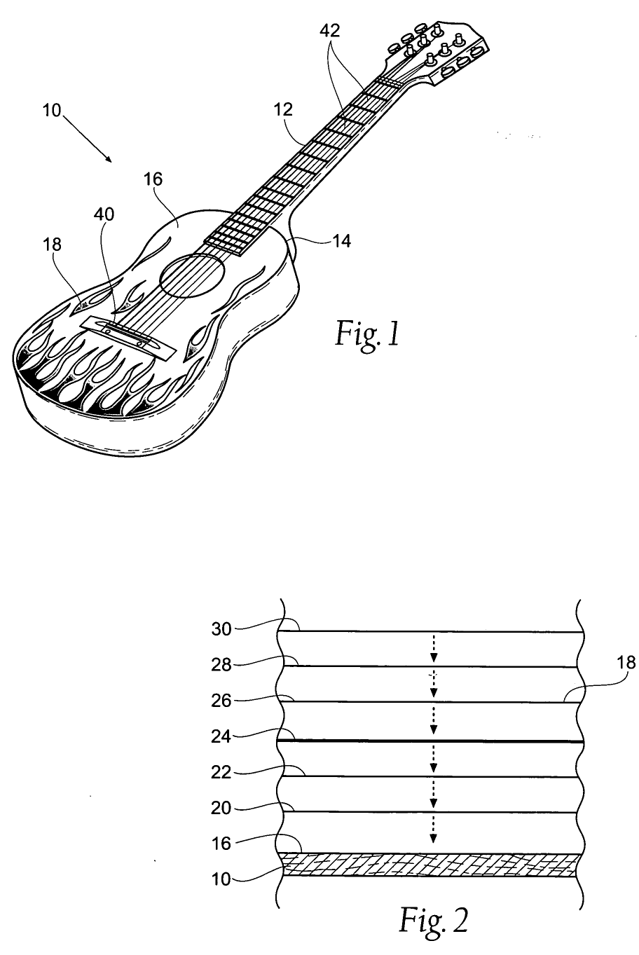

FIG. 1 is a perspective view of a guitar 10 having a neck 12 and a body 14. The body has a soundboard 16. A custom design or image 18 has been applied to the soundboard 16 of the body 14 in accordance with the present invention. The custom design 18 could include decals, silk-screening, a printing on a clear paper or media, or other detailed image. The custom image or design 18 should be considered broadly and not be limited to any specific type of custom picture or representation. The image 18 appears and feels as though it is an integral part of the soundboard 14. There are no exposed edges of the image 18, which prevents the image 18 from peeling off of the guitar and does not impede the strumming of a person using the guitar 10.

FIG. 2 shows a partial side exploded view of the guitar 10. The image 18 is one of several layers applied to the guitar. The soundboard 16 is initially buffed using a buffing wheel, prior to any coatings being placed upon the guitar. The buffing is done to the raw wood surface of the guitar without any filing needed. A first undercoating layer 20 is preferably hand painted on top of the soundboard 16. The first layer 20 is allowed to dry, and then a second polyethylene undercoating layer 22 is applied over the first layer 20. The first layer 20 may be buffed before applying the second layer 22, preferably hand buffing the surface. After the second layer 22 is applied, the surface is allowed to dry. Preferably, drying takes place at room temperature, and the guitar 10 is allowed to dry for approximately 48 hours. The drying time may be varied depending on such conditions as relative humidity of the surrounding air and other similar environmental conditions as necessary. This provides for a smooth even finish for the remaining layers of the process. Once the guitar 10 dries, a third layer of body paint 24 is applied over the second surface and allowed to dry. The third layer 24 is applied preferably with a spraying process. However, it is possible that the third layer 24 may not be needed at all. Depending on the color of the soundboard 16 and the image 18, the third layer 24 is possibly not necessary.

After the third layer of body paint 24 is applied to the guitar 10, a fourth layer 26 comprising the image 18 is applied to the guitar 10. Once this dries, a fifth layer of protective paint 28 and a sixth layer of finishing paint 30, both of which are preferably polyurethane products, are applied to the guitar 10. The guitar 10 can be buffed between application of the fifth layer 28 and the sixth layer 30. The finished product is the guitar 10 shown in FIG. 1. However, it is understood that the image shown in FIG. 1 is merely exemplary of any of several images that may be applied to the guitar 10.

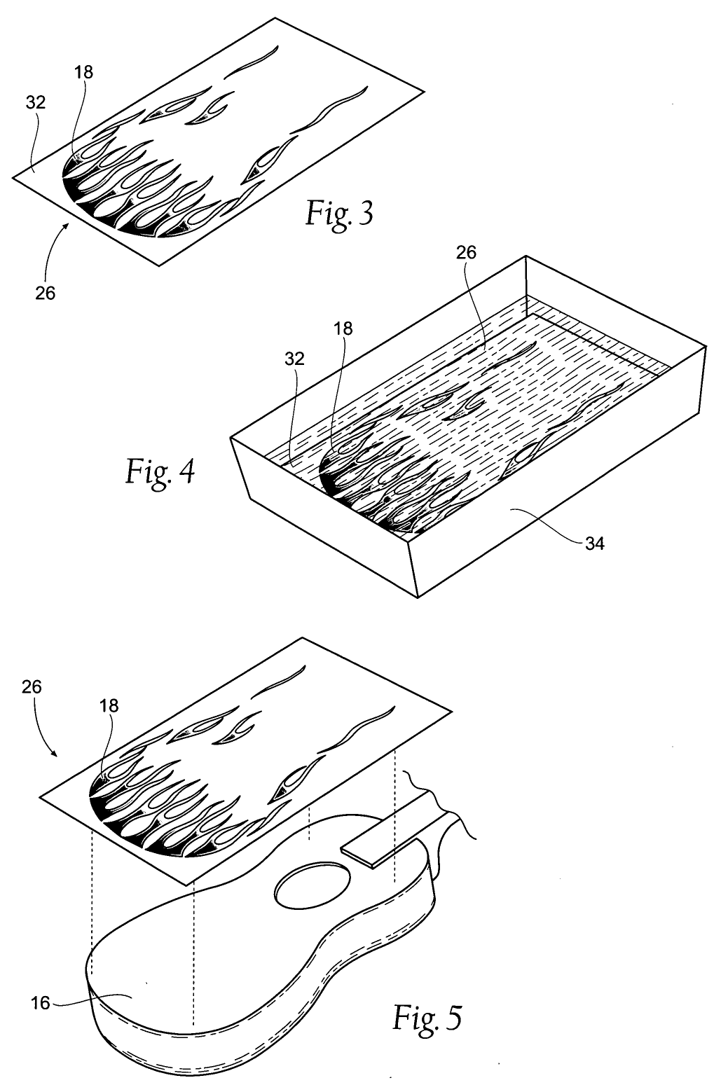

Referring now to FIG. 3, the fourth layer 26 is shown. The fourth layer 26 is shown as being a rectangular backing sheet 32 with the image 18 located upon the sheet 32. However, once the layer 26 is placed upon the guitar 10, the sheet 32 will be removed, leaving only the image 18 on the guitar 10. As shown, the image 18 can be fairly detailed and intricate. The present process allows such intricate and detailed images to be placed on a guitar in a quick and efficient manner, without noticeably affecting the quality of the image or the quality of the soundboard of the guitar.

FIG. 4 shows the backing sheet 32 and the image 18 being treated for application onto the guitar. The image 18 is adjoined to the backing sheet 32, preferably with an adhesive material, such as glue or similar material. The layer 26 is moistened, preferably by placing the layer 26 within a container of liquid 34. Depending on the type of adhesive material used, any number of liquids may be used to moisten and loosen the image 18 from the backing sheet 32. For environmental and safety reasons, the liquid is preferably water, and the adhesive material is preferably water-soluble. As previously noted, the image 18 can consist of different mediums, such as silk screening, decals, printings and the like, and such images would be applied accordingly as currently known in the art.

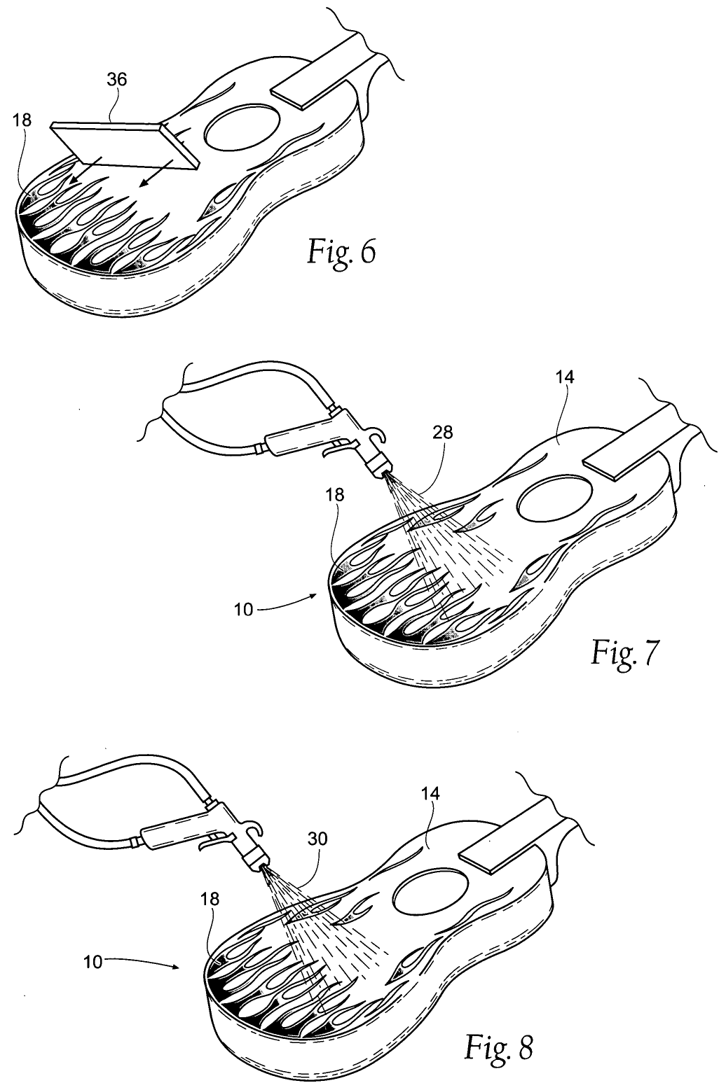

FIGS. 5 and 6 show the layer 26 being applied to the guitar 10. Once the image 18 is aligned with the soundboard 16, a smoothing device 36 will be used to make sure the image 18 is flat and evenly arranged. Once properly positioned, the backing sheet 32 can be removed, and the image 18 can be allowed to dry.

FIG. 7 shows a perspective view of the guitar 10. Now that the image 18 has sufficiently set, the fifth layer of protective paint 28 may be applied to the guitar 10. The fifth layer 28 can be sprayed upon the guitar 10, but any other similar known processes of applying paints and similar covering materials may also be used.

Once the fifth layer 28 is sufficiently dry, the sixth layer of finishing paint 30 is applied to the guitar 10, as is depicted in FIG. 8. The fifth layer 28 and the sixth layer 30 can be applied in the same fashion. The bridge 40 and the strings 42 will then be added to the guitar 10. The result is the finished guitar 10 shown in FIG. 1. The guitar 10 has an intricate image 18 located on the soundboard 16 that is protected from damage and, also, gives the appearance that it is integral with the soundboard 16 itself.

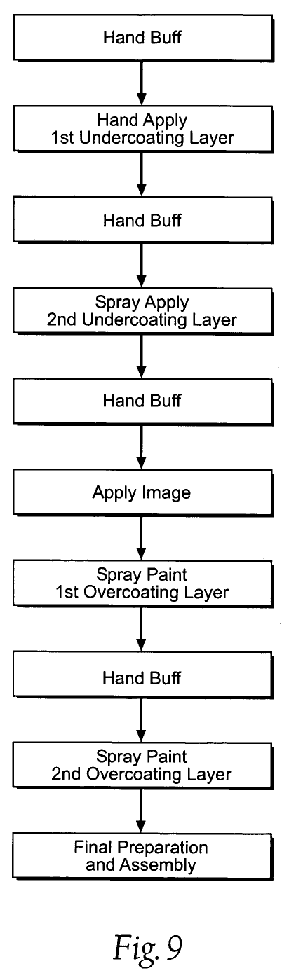

FIG. 9 provides a flow chart of a preferred method used in the present invention. Care is taken with each layer that is put upon the guitar, with the guitar surface being buffed often, preferably hand buffed to take care not to damage the guitar or soundboard. Also, the method insures that the applied image will be sufficiently protected, with paint layers above and below the image to protect the image. The result is a method that provides an efficient process that can be duplicated easily to produce a high-quality aesthetically appealing guitar.

As stated, the preferred undercoating is polyethylene. However, any similar polyester, polyether, aliphatic, or aromatic polymer that is used in the industry will be sufficient. Similarly, other known finishing paints may be used in place of the hi-gloss paint.

The resultant guitar from the present process achieves a finished guitar previously not achievable with prior art processes. The image 18 appears as though it is actually imprinted on the soundboard 16. This desired effect is beneficial for several reasons. The image will not peel or crack and will not interfere with strumming or picking of the guitar 10. The image 18 can be applied quickly to the guitar, as compared with prior art processes. Also, the process is much more economical than processes where the soundboard, itself, has an image imprinted upon it. There is less chance of damage to the soundboard by the present process and, also, the present process can be repeated easier and quicker. While prior art processes may have applied a sticker or the like to the front of a guitar, none of the prior art processes were capable to provide an image to a guitar of high end quality, while still being able to produce the guitars in a mass-production style. This especially holds true for acoustic guitars. Prior art has not contemplated putting an intricate image onto a high-end acoustic guitar in an efficient manner. Thus, the present invention provides a wide range of aesthetically pleasing guitars of high quality that were previously not known.

The process is less time consuming and more efficient than prior processes used for customizing electric guitars. Because a complete image is being applied to the guitar, less time is required to insure that a design is properly painted onto the guitar. Similarly, the same image may be applied to several guitars quickly and efficiently, thereby allowing guitars to be manufactured with designs having consistent quality. The present method is also an improvement on guitars that would have images preprinted or imprinted on the body or the soundboard. Because a manufacturer may not know exactly which designs consumers may prefer, the present method allows the manufacturer to produce small quantities of several designs without ending up with large excess amounts of guitars that people find undesirable. Furthermore, there is more chance of damage or alteration to the body or soundboard of the guitar when the image would be imprinted or preprinted, thereby potentially diminishing the sound or tonal quality of the guitar.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A method of applying a custom image to a guitar, the method comprising the steps of:
buffing said guitar;
applying an undercoating layer to said guitar;
drying said guitar;
laminating said image to said guitar; and
applying a layer of protective paint to said guitar.

2. The method according to claim 1 wherein said step of buffing comprises buffing the guitar with a buffing wheel.

3. The method according to claim 2 further comprising a second step of buffing said guitar, said first step of buffing said guitar being performed before applying said undercoating layer, said second step of buffing said guitar being performed after applying said undercoating layer.

4. The method according to claim 3 wherein said step of applying said undercoating layer comprises hand painting said undercoating layer.

5. The method according to claim 4 further comprising the step of:
applying a second layer of undercoating to said guitar.

6. The method according to claim 5 wherein said first and said second layers of undercoating are a polyethylene material.

7. The method according to claim 6 further comprising the step of
applying a layer of transparent paint to said guitar.

8. The method according to claim 7 wherein said transparent paint is a hi-gloss paint.

9. A method of applying a custom image to a soundboard of an acoustic guitar, the method comprising the steps of:
buffing said guitar
applying by hand a first undercoating layer to said soundboard;
drying said soundboard;
applying a second undercoating layer to said soundboard;
laminating said image to said soundboard; and
applying a layer of protective paint to said soundboard.

10. The method according to claim 9 wherein said step of buffing comprises buffing the guitar with a buffing wheel.

11. The method according to claim 10 further comprising a second step of buffing said guitar, said first step of buffing said guitar being performed before applying said first undercoating layer, said second step of buffing said guitar being performed after applying said first undercoating layer.

12. The method according to claim 11 wherein said step of applying said second undercoating layer comprises spraying said second undercoating layer on said guitar.

13. The method according to claim 13 wherein said first and said second layers of undercoating are a polyethylene material.

14. The method according to claim 12 further comprising applying a second layer of protective paint to said soundboard.

15. The method according to claim 14 wherein said layers of protective paint comprise polyurethane materials.

16. The method according to claim 15 wherein said second layer of protective paint further comprises a hi-gloss paint.

17. The method according to claim 16 further comprising a third buffing step, said third buffing step being performed after applying said first layer of protective paint.

18. The method according to claim 17 wherein said step of laminating is performed using an adhesive on the image.

19. The method according to claim 18 wherein said drying time is approximately 48 hours.

20. A method of applying a laminate to a soundboard of a guitar, the method comprising the steps of:
a first step of buffing said soundboard;
applying a first undercoating layer to said soundboard;
a second step of buffing said soundboard;
applying a second undercoating layer to said soundboard
drying said first and said second undercoating layers for approximately 48 hours;
applying a third layer comprising an image to said surface;
applying a fourth layer of protective paint to said surface; and
a third step of buffing said soundboard; and
applying a fifth layer of finishing paint to said surface.
